(19) United States
(12) Patent Application Publication
(10) Pub. No.: US 2023/0146326 A1
(43) Pub. Date: May 11, 2023

(54) RFID SECURITY LABEL FOR PACKAGING

(71) Applicant: Avery Dennison Retail Information Services LLC, Mentor, OH (US)

(72) Inventors: Pedro GARZA, Austin, TX (US); Julie VARGAS, San Antonio, TX (US); Jayne BLAIR, Miamisburg, OH (US)

(21) Appl. No.: 17/904,921

(22) PCT Filed: Feb. 26, 2021
(86) PCT No.: PCT/US2021/019956

§ 371 Date: Aug. 24, 2022

Related U.S. Application Data
(60) Provisional application No. 62/982,022, filed on Feb. 26, 2020.

(51) Int. Cl. G09F 3/03; G06K 19/07; G06K 19/077; G09F 3/00; G09F 3/10; B65D 33/34; B65D 33/16

(52) U.S. Cl. CPC G09F 3/0341; G06K 19/0723; G06K 19/0776; G09F 3/0376; G09F 3/0297; G09F 3/10; B65D 33/34; B65D 33/1691; G09F 2003/023

(57) ABSTRACT

The present invention relates to a closure mechanism, such as a label construction, for a wide variety of packages. The closure mechanism may provide for a security means as well and can be provided with a radio frequency identification (RFID). The closure mechanism may comprise at least one label having at least one RFID device on either a first or second face of the label such that the label is applied to a package wherein the package is subject to a first and second state conditional upon the positioning of the at least one label positioning. The present invention also provides for a method of making and utilizing the label on at least one packaging.

### CROSS-REFERENCE TO RELATED APPLICATIONS

The present application claims the benefit of U.S. Provisional Patent Application No. 62/982,022 filed Feb. 26, 2020, which is incorporated herein by reference in its entirety.

### FIELD

The present invention is directed to a secure closure label that may be used on packaging, containers, bags, envelopes and the like for various purposes such as, but not limited to, sealing securing and closing purposes.

### BACKGROUND

There exists a need in the market for a closure and security label for packaging. Different types of packaging such as bags, envelopes, totes13 plastic or paper, are used in supply chains, personal convenience and retail environments in order to carry, transport and store products and items and move them from one location to another. The containers aid in the ease of the consumer experience when shopping. As the market leans toward an environment in which there is a priority placed on ease to the consumer, there are retail methods currently being utilized where a consumer may place an order online via a web portal or an application on a cellular device, for a retail item or a consumer item. The consumer is provided with an opportunity to avoid traveling to a retail outlet and needing to shop within the confines of the store for a particular item or wait in line in order to purchase the item. Rather, the consumer is able to remotely purchase an item and go to a defined station which may or may not be within the retail environment in order to quickly pick up the item, saving the consumer time and creating an easier shopping experience. Alternatively, the packaged item may be delivered directly to the home or office location of the consumer.

In utilizing this type of remote purchase process, the goods or items that are being purchased by the consumer may be put into some sort of packaging while the goods are placed in a holding area for the consumer to come pick up the goods or while the package is waiting for collection by a courier service. While the goods are in the packaging, it is often desirable, especially if the goods are perishable such as food items, that the packaging be sealed rather than subject to ambient or room temperature conditions. In addition, by placing the goods in a sealed package it protects the goods from potentially being tampered with. By keeping a package in a closed or sealed state it allows for perishable items to be kept in an environment less subject to outside temperature changes and other conditions.

Thus, there exists a need for a type of closure system that keeps a package closed in a variety of conditions, including for example temperature and humidity. For instance, if the goods remotely purchased by a consumer are perishable food items, the goods will need to be placed in a refrigerated or freezer environment until the consumer comes to claim the goods, or a courier service picks up the package, in order to prevent spoilage. Thus, the closure of the package needs to be able to withstand the temperature change from moving the package from a manufacturing environment to a refrigerated environment.

It is also desirable that a closure system provides for a security measure so that the consumer can feel confident that the goods he or she remotely purchased were not tampered with or altered after being placed within the package. It may also be desirable for the manufacturer, retailer or distributor to take inventory and keep track of what goods were placed within the package for inventory management and freshness tracking in connection with perishable goods.

### BRIEF SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Closure mechanisms for at least one package that will remain securely closed in a variety of different environments are described herein. The closure label may also provide a security component which allows for the goods to remain enclosed and provides proof of tampering after being placed in the package.

A label that may be used for security and/or closure purposes with a variety of packages or containers is set forth. The label in one embodiment, has a substrate provided with an adhesive layer and a release liner. The label may also contain a radio frequency identification (RFID) device integral with the label.

Methods of making a label for security and/or closure purposes and utilizing the label on a wide variety of packaging are provided. A package is provided having a top and bottom portion and a front and back section such that a good or consumer item may be inserted into the package through an opening, such as in the top portion of the package, and the good will come to rest within the bottom portion or area of the package. An adhesive layer is provided on the label and a release liner may be adhered over the adhesive layer. In order to place the label on a package, the release liner, if used, is removed from the label construction. A first area of the front and back section of the package is folded creating a first folded section. The label is then attached to the first folded section and to a second area of the front section of the top portion of the package. It is also contemplated that the front and back section may be folded a plurality of times creating more than a first folded section.

Other features and advantages of the present disclosure will become apparent to those skilled in the art from the following detailed description. It is to be understood, however, that the detailed description of the various embodiments and specific examples, while indicating preferred and other embodiments of the present disclosure, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a plan view of the label of the present invention.

FIG. 2 depicts a cross section view of the label of the present invention.

FIG. 3 illustrates a chart of testing data of the label of the present invention.

FIG. 4 illustrates the label of the present invention adhered to a packaging.

FIG. 4A illustrates a prior art label lifting from the surface of a package

FIG. 5 illustrates a front view of a label attached to a package.

FIG. 6 shows a block method of making and applying a closure mechanism or label to at least one package of the present invention

FIG. 7 shows a top view of the package of the present invention.

FIG. 8 illustrates a label construction of the present invention having at least one RFID device.

FIG. 8A illustrates one embodiment of the label construction of the present invention having at least one RFID device.

FIG. 9 illustrates another embodiments of the label construction of the present invention having at least one RFID device.

FIG. 9A illustrates an additional embodiment of the label construction of the present invention having at least one RFID device.

### DETAILED DESCRIPTION

The closures mechanisms and methods disclosed described herein are described in detail by way of examples and with reference to the figures. Unless otherwise specified, like numbers in the figures indicate references to the same, similar, or corresponding elements throughout the figures. It will be appreciated that modifications to disclosed and described examples, arrangements, configurations, components, elements, apparatuses, methods, materials, etc. can be made and may be desired for a specific application. In this disclosure, any identification of specific shapes, materials, techniques, arrangements, etc. are either related to a specific example presented or are merely a general description of such a shape, material, technique, arrangement, etc. Identifications of specific details or examples are not intended to be, and should not be, construed as mandatory or limiting unless specifically designated as such. Selected examples of apparatuses and methods are hereinafter disclosed and described in detail with reference made to FIGURES.

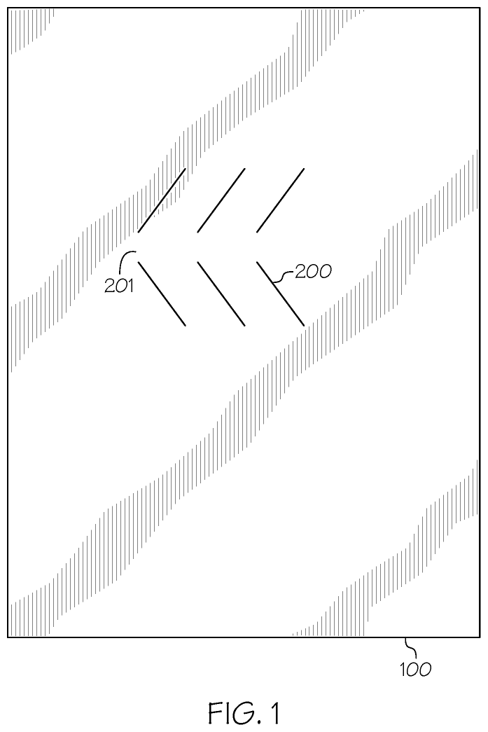

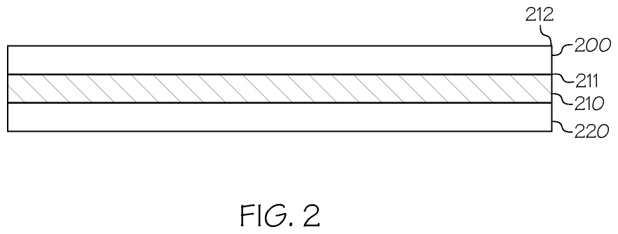

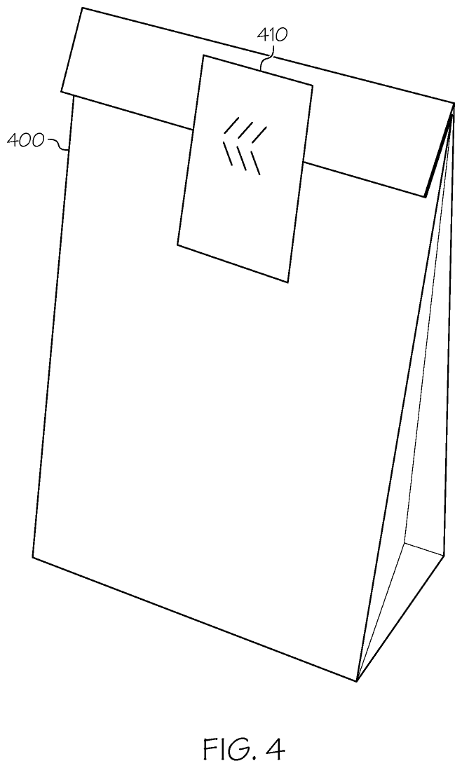

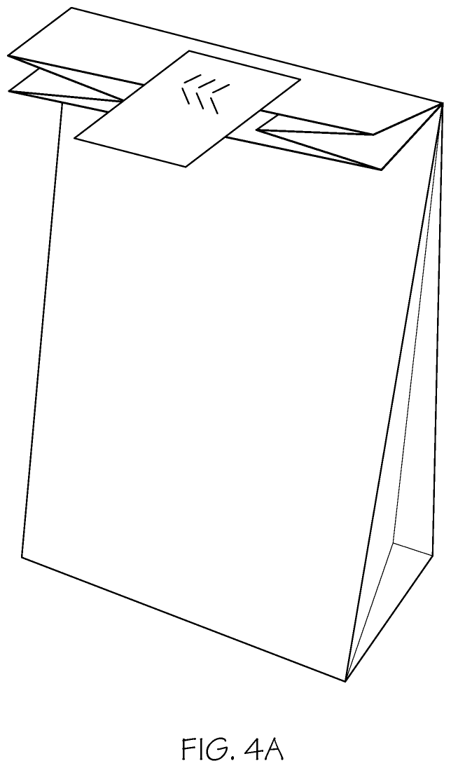

Embodiments of the present disclosure provide for a label or closure mechanism that may be used for various purposes such as to close or seal a package and/or other various security measures for a package. For instance, the closure mechanism of the present disclosure may be an adhesive label with tamper evident features and may be used in order to determine whether or not a particular package has been opened or altered by a third party. For instance, if the overall construction of the label design set forth in the Figures is shown as torn or altered in any way it would indicate to an end user that the contents of the packaging have been altered or the contents have been viewed by someone other than the desired end user. Attention is direction to FIGS. 1 and 2 of the present invention which illustrate two different viewpoints of the label described herein. As illustrated in FIG. 1, the label presently set forth contains a plurality of apertures or openings 200. These apertures may be tiny openings, slits, cuts or perforations. When torn, these apertures cause the label to rip/break/tear apart in a way that show the label has been pulled or otherwise tampered with. These apertures 200, in one embodiment, presently contemplated are stress relief cuts which in one embodiment, may be angled so as to prevent the label when adhered to packaging from “lifting up” from the surface of the package before the time frame it is desirable to remove the label from the package in order to gain access to the contents of the package. FIG. 4 illustrates the label of the present disclosure having a plurality of apertures, perforations, cuts or slits adhered to a package. FIG. 4a illustrates the label of the present disclosure lifting from a surface of the package which may be undesirable if the lift happens prior to the intended end user gaining access to the package. If the label lifts from the surface of the package it is impossible to maintain the integrity of the contents of the package evidencing tampering or intervention into the content ahead of intended one.

In one embodiment of the present disclosure, the label 100 has a perimeter including a length and a width. The width and the length of the label may be equal to one another or as illustrated in FIG. 1, the length may be slightly longer than the width of the overall label. For instance, while it is worth acknowledging that the length and width of the label are not limited to any particular measurement, the length may be 4 inches and the width may be 3 inches, in one embodiment. In addition, while the label is shown in a generally rectangular or square configuration, it should be understood that the label may take any geometric shape, or may be provided in an alpha or numeric configuration or as part of a branding or trade dress design.

As shown in FIG. 1, the plurality of apertures 200 may be plurality of slits or perforations. For illustration purposes, the plurality of slits 200 may be arranged in a series of horizontal rows. However, it is contemplated that the slits 200 may also be arranged in numerous configurations such as, but not limited to a plurality of columns, rows, diagonal or even randomly disposed. The slits 200 in FIG. 1 are shown arranged in horizontal rows that are angled creating a channel between 201 the rows or columns. The channel 201 may be an area of the label between the plurality of apertures or slits 200 of FIG. 1 which do not comprise any sort of opening, slit, or perforation.

The packaging to which the label 100 of FIG. 1 is adhered may be any sort of packaging known in the art. In one embodiment the packaging may be a cellulosic material such as paper bag, paperboard container, carton or the like. It is also contemplated that the packaging could be any sort of plastic packaging, container, or mixed material type of packaging, including post-consumer waste based material, recycled material or materials derived from sustainable or renewable resources.

FIG. 2 illustrates a cross sectional view of a label as presently set forth. The substrate 200 has a top 212 and bottom 211 face. The substrate 200 has an adhesive layer adhered to the bottom face 211. The adhesive layer may be pattern or curtain coated adhesive or applied to a perimeter of the substrate 200. The adhesive layer, in one embodiment, may be a rubber based adhesive having a high initial tack and ultimate bond strength to a wide variety of different substrates, especially to corrugated and higher recycled-content materials. The adhesive layer is designed to perform well in a wide variety of environments, such as in low temperature, refrigerator/freezer temperature ranges, extremely high temperature ranges, humidity and the like which would be helpful in a non-temperature controlled environment such as shelf stable items. In one embodiment, a hot melt rubber adhesive is utilized and the label is used on a package in a minimum application temperature of +10° F. (−12° C.) and a service temperature range of −65° F. to +160° F. (18° C.-71° C.). The present disclosure recognizes that it is preferred that the adhesive utilized is a GRAS (Generally Recognized as Safe) certified adhesive formulation if the label construction of the present invention is utilized on a package for a food item and has indirect food contact.

While the label of the present disclosure may be applied to a package, it is also contemplated that the label presently set forth having a plurality of apertures is attached to a packaging with a mechanical mechanism, e.g. fasteners, staples, cooperating structures, etc. and no adhesive is utilized. It is also contemplated that a mechanical mechanism in cooperation with an adhesive layer may be used to attach the label to a package. The mechanical mechanism in one embodiment may be a hook and loop type mechanism.

It is contemplated by the present disclosure that the top face 212 of the label may include indicia such as marketing material for a company, a logo, a trademark etc. The indicia may be fixed or variable data that is printed via an ink jet printer or other printer known in the art. It is also contemplated the top face 212 may include a radio frequency identification (RFID) device adhered to the top face 212 or to the bottom face 2011 of the label. The RFID device may also be applied immediately adjacent the label and separable by for example a line of perforations or tear strip. While it is illustrated that the label is an opaque white, the color of the label may be any color contemplated in the art.

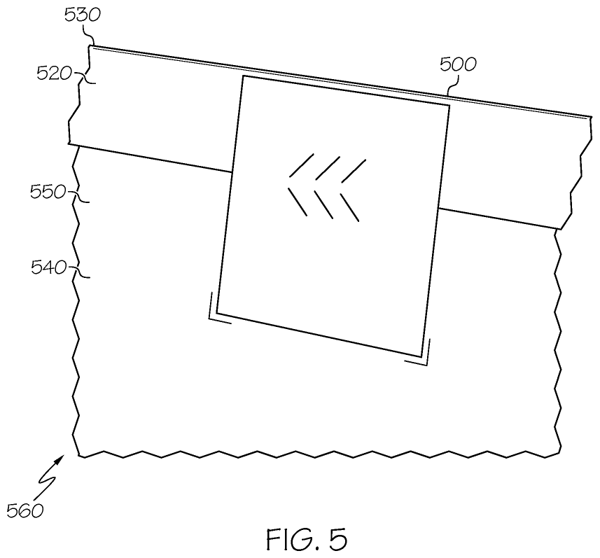

FIG. 5 illustrates a label of the present disclosure attached to a package. As seen from the Figure, the packaging 500 has a front 540 and back section 530. The packaging also has a top 550 and bottom portion 560, the bottom portion being where goods typically rest when put inside the packaging. The packaging 500 can be in a first state such as an open state, where goods are able to be placed in the package and a second state in which the package can be in a closed state which is illustrated in FIG. 5. Alternatively, the packaging can be formed around the product as part of a packaging or processing line. In the open state, the packaging has an opening allowing for goods to be placed within. In the second state or the closed state, a label 500 may be adhered to a folded area 520 of the packaging 500 which is created from bringing the front 540 and back section 530 of the package together and folding an area of both the front 540 and back section 530 of the packaging 500. While it is stated that the first state of the packaging 500 may be when it is open and the second state may be when the packaging 500 is closed, it is worth noting that the reverse is also true and the second state may be when the packaging is open and the first state may be when the packaging is closed.

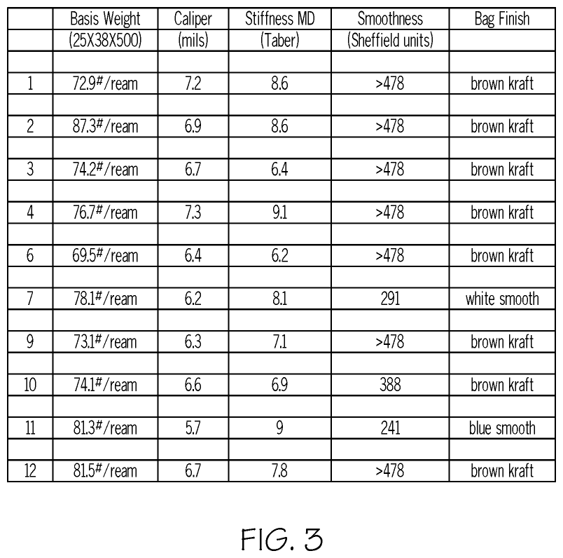

The construction of the label presently set forth ideally has the ability to keep a package, of any type known in the art, closed for at least a minimum of twenty-four (24) hours in a variety of environmental conditions including a freezer or refrigerated temperature range. Testing was performed for different packaging and ten different packaging types to determine the longevity of the label present set forth. The results of the testing are illustrated in FIG. 3.

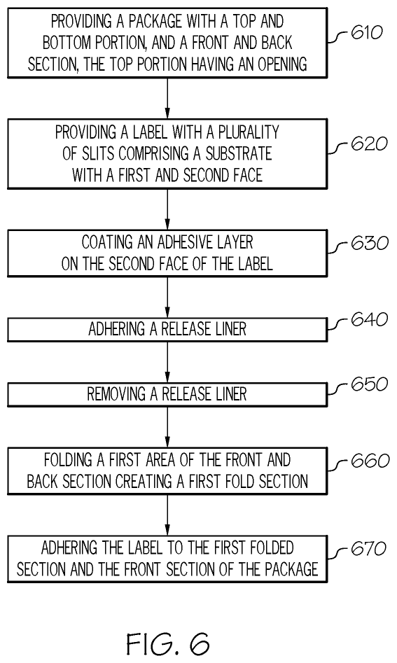

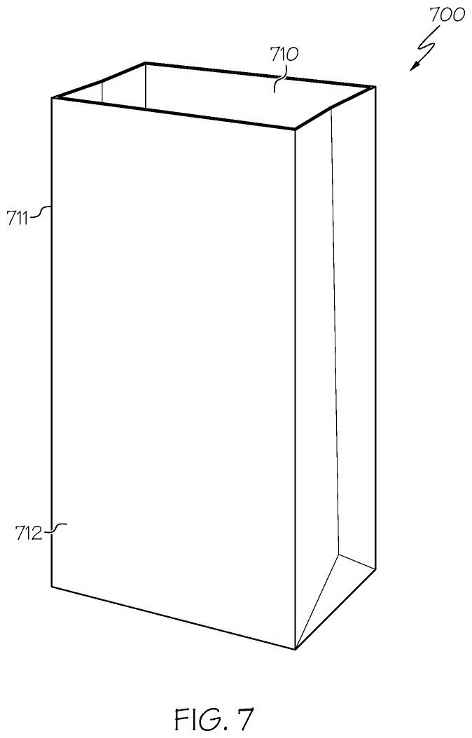

The present disclosure also provides a method of applying the label presently set forth to a package. FIG. 6 illustrates a method of application and utilization of the label present set forth. First at least one package is provided having a top and bottom portion and a front and back section in step 610. The top portion 711 may have at least one opening as best visualized in FIG. 7 which shows the overall structure of the package 700 having at least one opening 710 in which goods are often placed into. FIG. 7 also illustrates the bottom portion 712 of the package in which the goods are generally placed. The closure mechanism such as a label having a plurality of slits having a substrate with a first and second face is also provided 620. It is worth nothing that the slits or apertures provided may be made by any means known in the art such as a rotary die cutter, a mechanical cutter, a laser or a knife. Next, a coating is provided on the adhesive layer on a face of the substrate 630. A release liner may be adhered to the adhesive layer of the closure construction in step 640. In order to apply the closure mechanism to the at least one package, if a release liner is provided it must be removed in step 650. The release liner of the present disclosure may be made from any materials known in the art such as, but not limited to, a paper or plastic based film sheet. For instance, in one embodiment of the present disclosure, the release liner may be a polyester based material. It is worth noting that the present disclosure contemplates that the closure mechanism is simply applied to a face of the package, but it is also contemplated that a first area of the front and back section of the packaging are folded by a first fold section 660. The package is not limited to being folded a singular time, but may be folded a plurality of times creating a plurality of folded sections prior to attaching the closure mechanism to the at least one packaging. Lastly, the closure mechanism may be adhered to the first folded section 670 and a second area of the front section of the package.

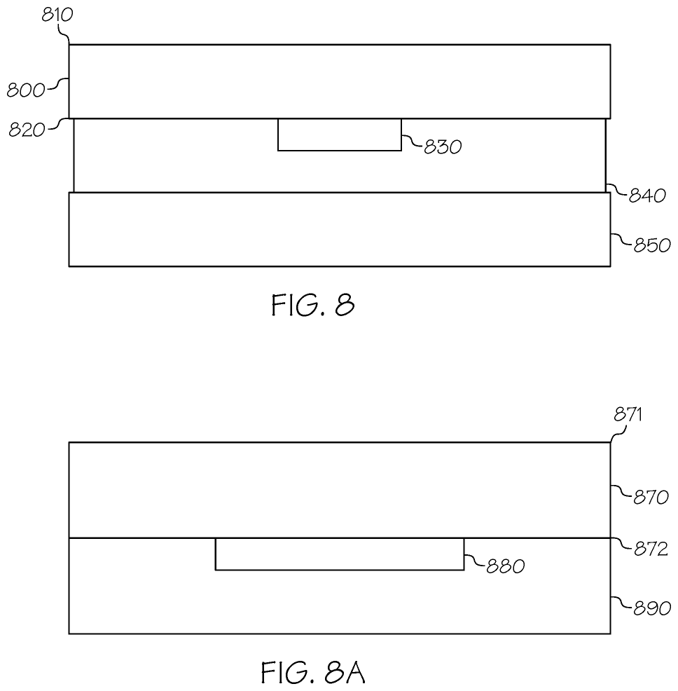

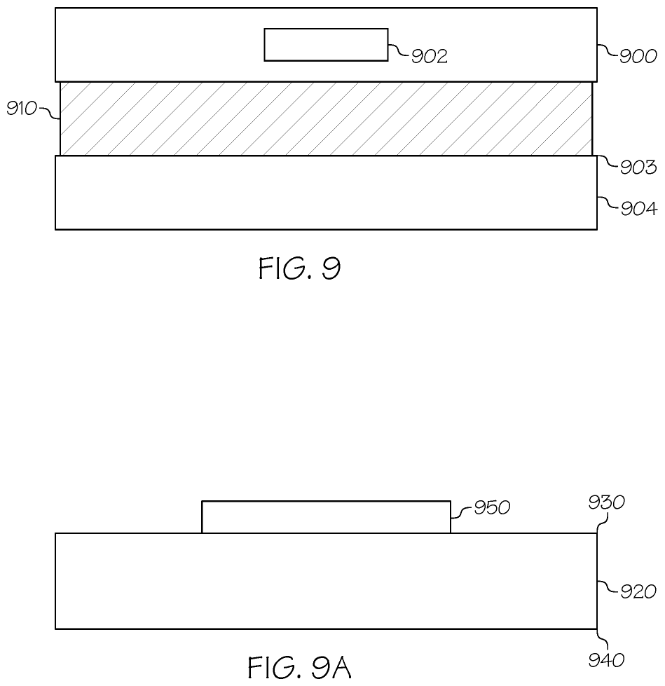

The present disclosure contemplates incorporating at least one RFID device within the label. As previously mentioned the at least one RFID device may be adhered to the top face of the substrate or incorporated within the substrate as set forth in FIGS. 9 and 9a. FIG. 9 illustrates the substrate 900 having at least one RFID device 902 incorporated herein by means known in the art. The adhesive layer 903 as indicated previously may be adhered to a release liner 904 resulting in a finished label construction 910. FIG. 9a illustrates that the at least one RFID device 950 may be adhered to a top face 930 or first face of a substrate 920 as opposed to the second face or bottom face 940. As illustrated in FIG. 8, that the at least one RFID device 830 may be attached to the second face 820 of a top layer 800 or substrate. The adhesive layer 840 of FIG. 8 surrounds the RFID device 830 and may be attached to a release liner 850. The first face 810 of the substrate may be attached to a coating layer (not pictured) in one embodiment of the present invention. It is also contemplated in FIG. 8a, that the RFID device 880 is attached to the second surface 872 of a top layer 870 of the overall label mechanism. Alternatively, the RFID device can be attached to the label along one side or the top or bottom edges and potentially separable from the label. The RFID device can be adhered to the package, be removably adhered or free from attachment to the package. The RFID device 880 may be attached to the top layer 870 having a top surface as well indicated by reference numeral 871 by means known in the art such as by a thin layer of adhesive that can be applied around the perimeter of the top layer 870 or like a peanut butter spread across the entirety of the area of the top layer 870. The adhesive layer could also be curtain or pattern coated as well. It is contemplated that the RFID device 880 is applied to the label so that it is on an area of the label separate from the plurality of apertures of the label. By providing a RFID device 880 within the construction of the closure mechanism, a level of security is provided as it can be determined for instance if the RFID devices passes by a reader, whether or not the package should be leaving a secure space such as a store. The RFID device may also be used for inventory tracking purposes and can be used to determine the contents of the package. It is also contemplated that the RFID device is positioned within or on the label or closure mechanism and on the package in such a way so that when the package is opened the antenna of the RFID device is “broken” or altered—breaking the current through the antenna—indicating that the package has been opened previously which may be a means for an end user to determine whether or not the package has been altered with prior to receiving the package for its end use. In addition, the RFID device can help with product recalls and other consumer alerts.

In another embodiment, a label for indicating tampering is provided. The label construction is as similar as described previously including in the Figure. 1 and 2, and includes as a substrate with a top face and bottom face. At least one RFID device containing a chip and connected antenna and the device is adhered either to the top or bottom surface of the substrate. An adhesive layer underlying the bottom surface of the substrate and a release liner underlying the adhesive layer. The substrate bears one or more apertures and the apertures are stress relief cuts and are angled. The label seals a package along an opening of the package. The apertures are located separate from the adherence location of the RFID devices. The RFID device is adherent to the substrate along the apertures. The stress relief cut breaks indicating tampering upon removal of the sealing along the opening. Alternatively, the RFID device breaks indicating tampering upon removal of the sealing along the opening.

The antenna of the RFID device of the present disclosure may include an antenna configuration and be of any construction known in the art such as, but not limited to dipole, monopole or sloop. It is also contemplated that the device used may be a dual RFID/electronic article surveillance device as well. The RFID device can be formed by directly applying a chip to the substrate/antenna or by a strap. In addition, the chip or integrated circuit can be formed by direct printing of the circuit to the package.

In another embodiment of the present disclosure, the RFID device included within the label structure of the present invention may include a microwave safe inlay. This allows for the packaging to be subject to microwave conditions which include both radiation and radio waves. The structure of the RFID device able to withstand a microwave, in one embodiment, has the structure as set forth and incorporated herein as US publication 2018-0189623.

While the drawings illustrate the utilization of a single closure mechanism, such as a label, on at least one package is it contemplated that the packaging of the present invention may also include a plurality of labels all of which may include a RFID device or only a few or one of the closure mechanisms may include a RFID device.

It will thus be seen according to the present disclosure a highly advantageous. security and closure label for packaging has been provided. While the mechanisms and methods have been described in connection with what is presently considered to be the most practical and preferred embodiment, it will be apparent to those of ordinary skill in the art that the disclosure is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A closure system for a package comprising:
a package having an area and at least a first and second section;
at least one of the first or second sections having an opening;
at least one label with at least one radio frequency identification (RFID) device associated with the package
wherein the package is subject to a first and second state conditional upon an at least one label positioning.

2. The closure system of claim 1, wherein the first state is an open state.

3. The closure system of claim 2, wherein the second state is a closed state.

4. The closure system of claim 1, wherein when the at least one label is applied to the package over the at least one opening, the package is in the closed state.

5. The closure system of claim 1, wherein the first section is a top portion of the package.

6. The closure system of claim 5, wherein the at least one opening is in the top portion of the package.

7. The closure system of claim 1, wherein the at least one label further includes a plurality of small apertures.

8. The closure system of claim 1, wherein the at least one label has a top and bottom face such that the top face includes indicia.

9. The closure system of claim 1, wherein the package is a bag.

10. A label for packaging comprising:
a substrate having at least a top and bottom face;
an adhesive layer adhered to the bottom face of the substrate; and
a security label having a plurality of slits on the top face of the substrate.

11. The label of claim 10, wherein the security label further comprises at least one RFID device.

12. The label of claim 10, wherein the adhesive is a rubber based adhesive.

13. The label of claim 10, wherein the adhesive layer is pattern coated.

14. The label of claim 10, wherein the security label further comprises a release liner adhered to the adhesive layer.

15. The label of claim 14, wherein the release liner is a bleached Kraft stock.

16. The label of claim 10, wherein the label is adhered to an opening of a package providing both a closure and security means.

17. A method of making and using a RFID label for a package comprising the steps of:
providing a package with a top and bottom portion and a front and back section, the top portion having at least one opening;
providing a label with a plurality of slits, each of the slits subject to tearing forces to indicate tampering,
the label comprising a substrate having a first and second face and the label further able to be used in a plurality of environments;
coating an adhesive layer on one of the first and second faces of the label;
adhering a release liner to the adhesive layer;
removing the release liner from the adhesive layer;
folding a first area of the front and back section of the package creating a first folded section; and
adhering the label to the first folded section and to a second area of the front section of the top portion of the package.

18. The method of claim 17, wherein the label further comprises a RFID device.

19. The method of claim 17, wherein the plurality of slits comprises at least two rows of slits such that a channel separates the two rows of slits.

20. The method of claim 17, wherein the channel is free of any slits.

21. A label for indicating tampering, the label comprising:
a substrate with a top face and bottom face;
at least one RFID device comprising chip and connected antenna, the device being adhered either to the top or bottom surface of the substrate;
an adhesive layer underlying the bottom surface of the substrate and a release liner underlying the adhesive layer;
wherein the substrate bears one or more apertures;
wherein the apertures are stress relief cuts and are angled, and
wherein the label seals a package along an opening of the package.

22. The label of claim 21, wherein the apertures are located separate from the adherence location of the RFID devices

23. The label of claim 21, wherein the RFID device is adherent to the substrate along the apertures.

24. The label of claim 21, wherein the stress relief cut breaks indicating tampering upon removal of the sealing along the opening.

25. The label of claim 21, wherein 21, wherein the RFID device breaks indicating tampering upon removal of the sealing along the opening.
